(19) United States
(12) Patent Application Publication
(10) Pub. No.: US 2026/0004056 A1
(43) Pub. Date: Jan. 1, 2026

(54) INFORMATION PROCESSING APPARATUS, INFORMATION PROCESSING SYSTEM, AND INFORMATION PROCESSING METHOD

(71) Applicant: CASIO COMPUTER CO., LTD., Tokyo (JP)

(72) Inventor: Daiki SUMIOKA, Tokyo (JP)

(73) Assignee: CASIO COMPUTER CO., LTD., Tokyo (JP)

(21) Appl. No.: 19/245,782

(22) Filed: Jun. 23, 2025

(30) Foreign Application Priority Data
Jul. 1, 2024 (JP) 2024-105850

(51) Int. Cl. G06F 40/169; G06F 3/04817; G06F 3/04842

(52) U.S. Cl. CPC G06F 40/169; G06F 3/04817; G06F 3/04842

(57) ABSTRACT

An information processing apparatus includes a processor that is configured to, generate data for displaying on a display an electronic sticky note on which a character string that is accepted by input through a controller is displayed, a character count sign indicating a character count of the character string, and a target character count sign indicating a target character count for the character string obtained through the predetermined controller or a predetermined communicator, determine whether the character count of the character string is less than or equal to the target character count, and generate the data to display the character count sign in a different display manner on the display in a case in which the character count of the character string is less than or equal to the target character count and in a case in which the character count of the character string exceeds the target character count.

### CROSS-REFERENCE TO RELATED APPLICATIONS

This application claims priority and benefit of Japanese Patent Application No. 2024-105850, filed Jul. 1, 2024. The entire specification, claims, and drawings of Japanese Patent Application No. 2024-105850 are incorporated herein by reference.

### BACKGROUND OF THE INVENTION

### Field of the Invention

The present disclosure relates to an information processing apparatus, an information processing system, and an information processing method.

### Description of Related Art

Japanese Patent No. 5950634 discloses an information processing apparatus that displays an image of an electronic sticky note on a screen.

### SUMMARY OF INVENTION

According to the present disclosure, an information processing apparatus includes:
a processor, wherein the processor is configured to,
generate data for displaying on a display an electronic sticky note on which a character string that is accepted by input through a controller is displayed, a character count sign indicating a character count of the character string, and a target character count sign indicating a target character count for the character string obtained through the predetermined controller or a predetermined communicator,
determine whether the character count of the character string is less than or equal to the target character count, and
generate the data to display the character count sign in a different display manner on the display in a case in which the character count of the character string is less than or equal to the target character count and in a case in which the character count of the character string exceeds the target character count.

### BRIEF DESCRIPTION OF THE DRAWINGS

FIG. 1 is a schematic configuration diagram of an information processing system.

FIG. 2 is a block diagram showing a functional configuration of a server.

FIG. 3 is a diagram showing an example of a table containing sticky note management information.

FIG. 4 is a block diagram showing a functional configuration of a terminal apparatus.

FIG. 5 is a flowchart showing a control procedure of a display control process.

FIG. 6 is a diagram showing an example of a notebook screen with a sticky note placed on it.

FIG. 7 is a diagram showing an example of an edit screen that is in character input mode.

FIG. 8 is a diagram showing an example of the edit screen in a state with a character entered.

FIG. 9 is a diagram showing an example of the edit screen in a state in which a target character count is exceeded.

FIG. 10 is a diagram showing an example of the edit screen in a stamp input mode.

FIG. 11 is a diagram showing an example of the edit screen in a state with a displayed character string selected.

FIG. 12 is a diagram showing an example of the edit screen with a software keyboard displayed.

FIG. 13 is a diagram showing an example of the edit screen after correction.

### DETAILED DESCRIPTION

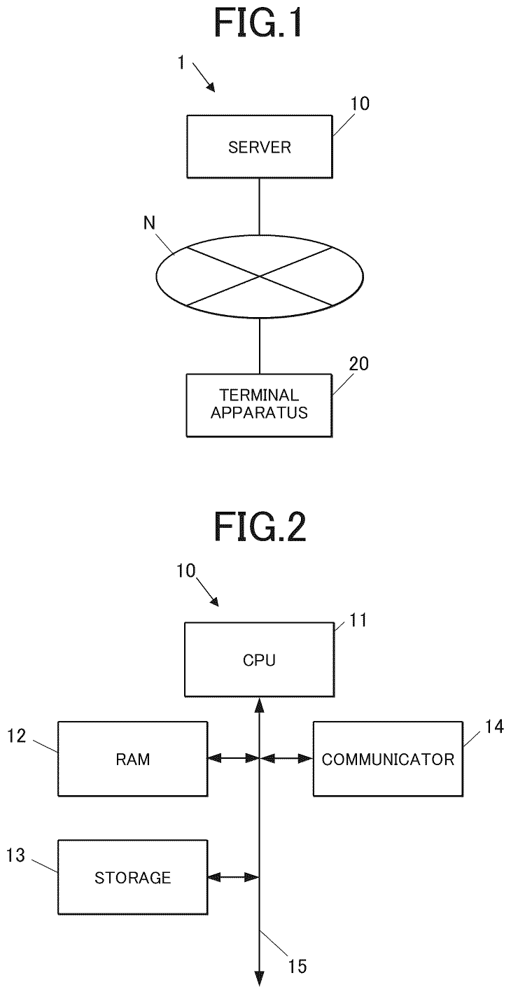

Embodiments of the present disclosure will be described below with reference to the drawings. First, a configuration of the present embodiment will be described with reference to FIG. 1. As shown in FIG. 1, an information processing system 1 includes a server 10 and a terminal apparatus 20 as information processing apparatus. The server 10 is connected to the terminal apparatus 20 via a communication network N to enable information communication. Although one terminal apparatus 20 is shown in FIG. 1, the number of terminal apparatuses 20 is not limited. The server 10 is for providing a cloud-based learning support service. The server 10 can provide, for example, a digital notebook function and a class support function as the learning support service. The terminal apparatus 20 is a terminal apparatus used by users (e.g., teachers and students) who use the learning support service described above. In the following, the terminal apparatus 20 will be described as a tablet PC (Personal Computer), but it may be a desktop PC, notebook PC, smartphone, etc. The communication network N shall be, for example, the Internet, but may be any other network, such as a Local Area Network (LAN).

Next, the functional configuration of the server 10 is described with reference to FIG. 2. As shown in FIG. 2, the server 10 is provided with a CPU (Central Processing Unit) 11 as at least one processor, a RAM (Random Access Memory) 12, a storage 13 as at least one memory, a communicator 14, and a bus 15. The various units of the server 10 are connected via the bus 15. The server 10 may be further provided with a controller, display, etc. to be used by an administrator, etc. of the server 10. The CPU 11 is a processor that reads and executes programs stored in the storage 13 and performs various arithmetic operations to control the operation of various units of the server 10. Although the single CPU 11 is illustrated in FIG. 2, it is not limited to this. Two or more processors such as CPUs may be provided, and these two or more processors may share and execute the processing performed by the CPU 11 according to the present embodiment. The RAM 12 provides a working memory space for the CPU 11 and stores temporary data. The communicator 14 performs a communication operation in accordance with a predefined communication standard. A communicator 14 uses this communication operation to send and receive information to and from the terminal apparatus 20 via the communication network N.

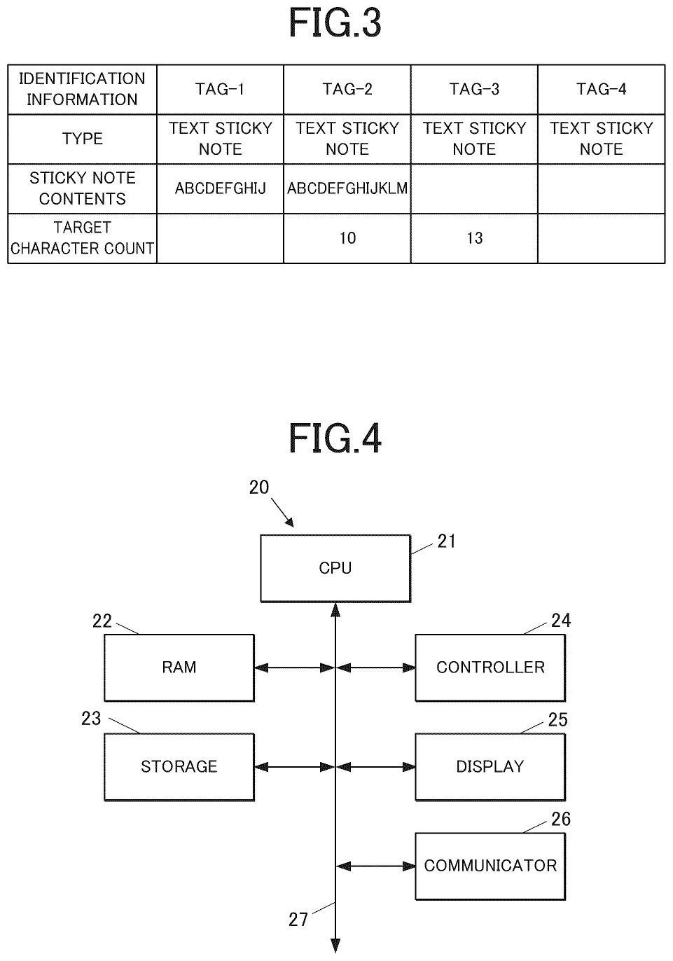

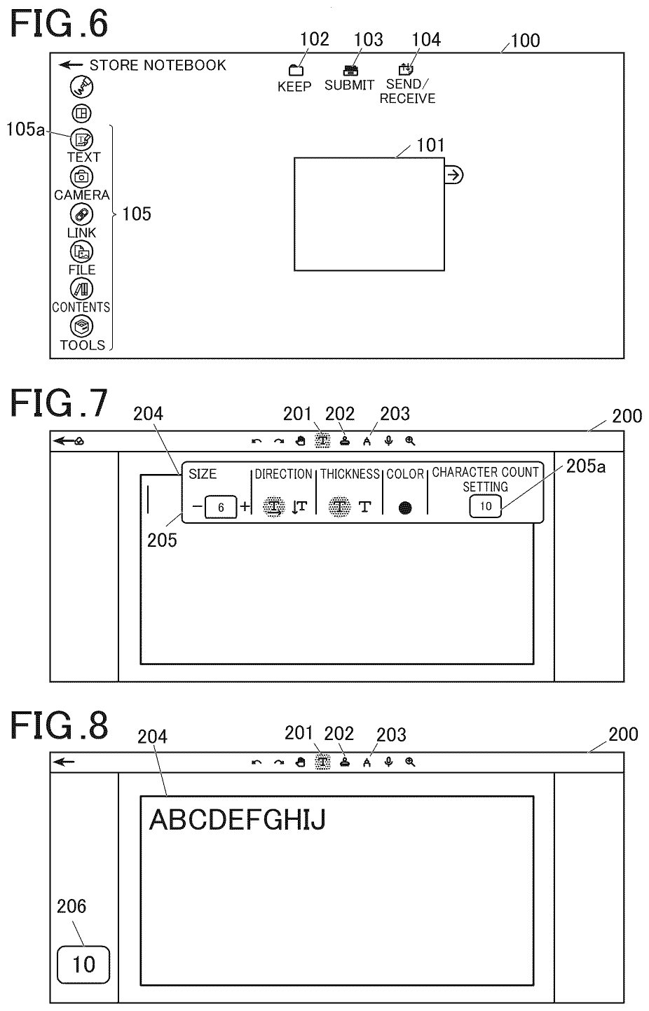

The storage 13 is a non-transitory recording medium readable by the CPU 11 as a computer, and stores various programs and various data. The storage 13 also stores a user database (not shown) that stores user information (user ID, password, basic information, etc.), which is information about a user who uses the learning support service. In addition, the storage 13 stores notebook management information that manages information pertaining to a notebook created by the user in the digital notebook function. The storage 13 stores the notebook management information for each user. The user can create a sticky note (electronic sticky note) in the digital notebook function and place such sticky note in the notebook. In the example of the notebook screen 100 displaying a notebook shown in FIG. 6, a sticky note 101 is placed in the notebook. The notebook is a notebook-type web component (digital component) that is a display element to be displayed on a display 25 of the terminal apparatus 20. The sticky note is a web component that records a learning item in various expressions. Here, an example in which a shape of the sticky note is a substantial rectangle is described, but it is not limited to this. The shape and size of the sticky note shall be such that it can be placed in the notebook. The user can move the sticky note placed in the notebook to any position in the notebook via the controller 24 of the terminal apparatus 20. The notebook management information includes identification information of target a notebook, identification information of the sticky note placed in the notebook, and coordinate information of the sticky note in the notebook, and the above information are mutually associated with each other. In addition, the storage 13 stores sticky note management information that manages information pertaining to the sticky note created by the user in the digital notebook function. The sticky note management information includes information such as identification information of the target sticky note, type of sticky note, and contents of the sticky note. The type of sticky note is information indicating the type corresponding to the sticky note, such as character sticky note, camera sticky note, link sticky note, file sticky note, contents sticky note, tool sticky note, etc. The sticky note content is information that indicates the contents of the sticky note and identifiably indicates a character string, an image, a video, etc. The sticky note contents also include information on display settings such as sticky note display size, background color, etc. An example of a table that stores the sticky note management information is shown in FIG. 3. In the example of the table shown in FIG. 3, the type of the sticky notes with the identification information Tag-1 to Tag-4 are character sticky notes, the sticky notes with the identification information Tag-1 and Tag-2 store the sticky note contents, the sticky notes with the identification information Tag-3 and Tag-4 do not store the sticky note contents, the sticky notes with the identification information Tag-2 and Tag-3 include the setting of a target character count for the characters to be displayed on the sticky note, and the sticky notes with the identification information Tag-1 and the identification information Tag-4 do not include the setting of the target character count for the characters to be displayed on the sticky note. The storage 13 stores the type of target sticky note, the contents of the sticky note, and the target character count associated with the identification information of the sticky note.

Next, the functional configuration of the terminal apparatus 20 is described with reference to FIG. 4. As shown in FIG. 4, the terminal apparatus 20 is equipped with a CPU 21 as at least one processor, a RAM 22, a storage 23 as at least one memory, a controller 24, a display 25, a communicator 26, and a bus 27. The various units of the terminal apparatus 20 are connected via the bus 27. The CPU 21 is a processor that reads and executes programs stored in the storage 23 and performs various arithmetic operations to control the operation of various units of the terminal apparatus 20. The RAM 22 provides a working memory space for the CPU 21 and stores temporary data.

The storage 23 is a non-transitory recording medium readable by the CPU 21 as the computer, and stores various programs and various data. The controller 24 accepts the input operation by the user and outputs the input signal corresponding to the input operation to the CPU 21. The controller 24 is provided with a touch screen superimposed on the display screen of the display 25, and the touch screen detects a contact of a stylus, a user's finger, or the like as an input operation. The controller 24 may be provided with a hardware button together with or in place of the touch screen, and this hardware button may be used so as to be able to accept the input operation. The display 25 displays the notebook screen 100 and other screens under the control of the CPU 21. The display 25 can be, for example, but not limited to, a liquid crystal display device that displays in a dot matrix fashion. The communicator 26 performs the communication operation according to the predefined communication standard. The communicator 26 uses this communication operation to send and receive information to and from the server 10 via the communication network N.

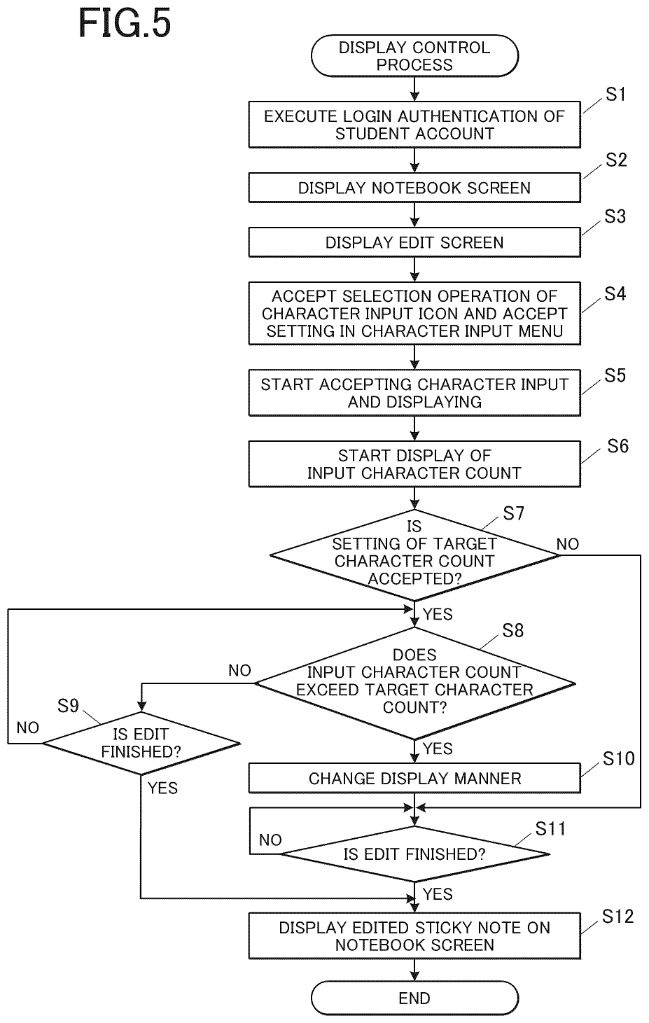

The operation of the information processing system 1 is described next. The following describes a case in which the user who is a student uses the digital notebook function on the terminal apparatus 20 in the information processing system 1. In this case, the CPU 21 of the terminal apparatus 20 executes the display control process shown in FIG. 5, which is a control step. First, the CPU 21, in cooperation with the server 10, performs login authentication of the student's account (step S1). Specifically, the CPU 21 of the terminal apparatus 20 executes a browser triggered by the input of a browser execution instruction from the user via the controller 24. Next, the input of the URL (Uniform Resource Locator) of the web page of the learning support service of the server 10 from the user via the controller 24 triggers the CPU 21 to, using the input URL, send a login request of the user via the communicator 26 to the server 10. Next, when the CPU 11 of the server 10 receives the login request from the terminal apparatus 20 via the communicator 14, the CPU 11 generates login screen data and sends it to the requesting terminal apparatus 20. Next, the CPU 21 of the terminal apparatus 20 receives the login screen data from the server 10 via the communicator 26 and displays it on the display 25. Next, the CPU 21 accepts the user ID and the password input from the user via the controller 24 and transmits the input user ID and the password to the server 10 via the communicator 26. Next, when the CPU 11 of the server 10 receives the user ID and the password from the terminal apparatus 20 via the communicator 14, the CPU 11 performs the login authentication of the user using the received user ID and password. Next, the CPU 11 provides the learning support service to the terminal apparatus 20 upon successful user login authentication. Next, the CPU 21 of the terminal apparatus 20 realizes the learning support service on the browser. Hereafter, the CPU 21 executes the digital notebook function, which is a type of learning support service, based on predetermined operations by the user via the controller 24.

Next, the CPU 21 obtains the notebook management information and the sticky note management information of the logged-in user stored in the storage 13 of the server 10. Next, the CPU 21 displays the notebook screen 100 displaying the notebook on the display 25 based on the acquired notebook management information and sticky note management information (step S2). As shown in FIG. 6, the notebook screen 100 includes a keep icon 102, a submit icon 103, a send/receive icon 104, and a button group 105. When the notebook screen 100 of a new notebook is displayed in step S2, no sticky notes are displayed on the initial notebook screen 100. The keep icon 102 is an icon for keeping the sticky note placed in the notebook screen 100 in a predetermined folder in a case in which the sticky note is dragged and moved onto the keep icon 102 by the user. The submit icon 103 is an icon for submitting the sticky note placed in the notebook screen 100 to a designated destination in a case in which the sticky note is dragged and moved onto the submit icon 103 by the user. The send/receive icon 104 is an icon for sending the sticky note placed in the notebook screen 100 to another user's account in a case in which the sticky note is dragged and moved onto the send/receive icon 104 by the user. The send/receive icon 104 is an icon for receiving the sticky note sent from another user's account in a case in which the user performs an operation of clicked input. The button group 105 is a plurality of buttons that accept a start instruction and other instructions to transition to the process of creating the sticky note to be placed on the notebook screen 100. The button group 105 includes a character button 105a. The character button 105a is a button for moving to the screen for creating the character sticky note that displays the character entered via the controller 24.

Next, the CPU 21 accepts an edit instruction operation for the sticky note 101, which is a character sticky note placed in the notebook screen 100, by the user via the controller 24, and displays on the display 25 an edit screen 200 (see FIG. 7) for editing information displayed on the sticky note 101 (step S3). As shown in FIG. 7, the edit screen 200 includes a character input icon 201, a stamp input icon 202, a handwriting input icon 203, and an input region 204. The character input icon 201 is an icon for accepting character input in the input region 204 in a case in which the character input icon 201 is clicked by the user. In other words, the character input icon 201 is an icon for instructing to execute the character input mode, which enables character input to the electronic sticky note. The stamp input icon 202 is an icon for accepting the placement of a stamp in the input region 204 in a case in which there is the click operation by the user. The handwriting input icon 203 is an icon for accepting handwriting input in the input region 204 in a case in which there is the click operation by the user.

Next, when the CPU 21 accepts the click operation of the character input icon 201 by the user via the controller 24, the CPU 21 displays a character input menu 205 on the edit screen 200, and accepts the setting operation related to character input (step S4). Specifically, the CPU 21 can accept operations to set the size of the character displayed in the input region 204, the direction in which the character is displayed, the thickness of the character, and the color of the character in the character input menu 205. The CPU 21 can also accept the setting of the target character count for the characters to be displayed in the input region 204 in the target character count input field 205a provided in the character input menu 205. In other words, the CPU 21 obtains the target character count via the controller 24 as the predetermined controller (obtainer). In a case in which the CPU 21 accepts the setting of the target character count, the CPU 21 associates the target character count with the identification information of the sticky note 101 and stores the above in the table of the sticky note management information stored in the storage 13. Next, the CPU 21 accepts the input operation of the character by the user via the controller 24 and starts displaying the characters in the input region 204 as necessary from the characters that are input (step S5).

Next, the CPU 21 starts displaying on the edit screen 200 a character count sign 206 indicating the character count input by the user (step S6), as shown in FIG. 8. In the example shown in FIG. 8, the character string input by the user is “ABCDEFGHIJ” and the character count of the character input by the user is “10”. In the example table shown in FIG. 3, the sticky note management information for identification information Tag-1 shows the case where the character string input by the user is “ABCDEFGHIJ”. The CPU 21 sets the character count of the character input by the user to “0” when no characters are input by the user. In other words, the CPU 21 displays “0” in the character count sign 206 at a time point that the CPU 21 starts accepting the character input. The CPU 21 then updates and displays the character count shown in the character count sign 206 each time the character is input by the user. In other words, the CPU 21 generates information for displaying on the display 25 the electronic sticky note on which the character string for which input is accepted via the controller 24 is displayed, the character count sign 206 indicating the character count of the character string, and the target character count input field 205a for which the input of the target character count for the character string is accepted. Then, the CPU 21 controls the display 25 based on the above information. The CPU 21 functions as a controller. Next, the CPU 21 refers to the sticky note management information stored in the storage 13 to determine whether the target character count has been set by the user in the target character count input field 205a (step S7). In a case in which the target character count has not been set (step S7; NO), the CPU 21 moves the display control processing to step S11 described below. On the other hand, if the target character count has been set (step S7; YES), the CPU 21 refers to the target character count as the sticky note management information stored in the storage 13 to determine whether the character count of the characters input by the user exceeds the target character count (step S8). In a case in which the character count of the characters input by the user is less than or equal to the target character count (step S8; NO), the CPU 21 determines whether the instruction operation by the user to terminate the editing of the information to be displayed on the sticky note 101 is accepted via the controller 24 (step S9). In a case in which the instruction operation to terminate the editing of the information displayed on the sticky note 101 is accepted (step S9; YES), the CPU 21 moves the display control process to step S12. On the other hand, in a case in which the instruction operation to terminate the editing of the information displayed on the sticky note 101 is not accepted (step S9; NO), the CPU 21 moves the display control process to step S8.

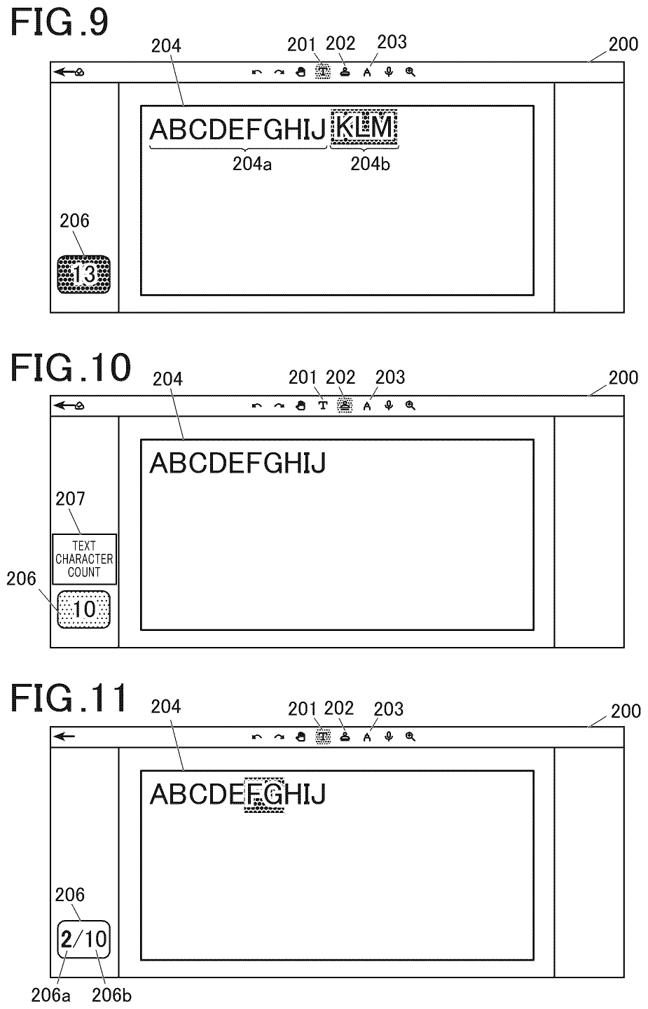

In a case in which the character count of the characters input by the user exceeds the target character count (step S8; YES), the CPU 21 changes a display style of the character displayed in the input region 204 and the display style of the character count sign 206 (step S10). In the example shown in FIG. 9, the target character count is “10”, the character string input by the user is “ABCDEFGHIJKLM”, and the character count of the characters input by the user is “13”. In the example table shown in FIG. 3, the sticky note management information for the identification information Tag-2 indicates a case in which the character string input by the user is “ABCDEFGHIJKLM” and the target character count is “10”. In other words, of the character string displayed in the input region 204, a character string 204a for first to tenth characters is a portion that is equal to or within the target character count counted from a beginning of the character string, and a character string 204b for 11th to 13th characters is the portion that exceeds the target character count counted from the beginning of the character string. In this case, the CPU 21 displays the character string 204b for the 11th to 13th characters in a different display manner from the character string 204a for the 1st to 10th characters. The CPU 21, for example, displays the background of the character string 204b, the 11th to 13th characters, in red. In other words, in a case in which the character count of the character string displayed on the electronic sticky note exceeds the target character count, the CPU 21 generates information to display the characters that are within or equal to the target character count counted from the beginning of the character string and the characters that exceed the target character count counted from the beginning of the character string in the character string displayed on the electronic sticky note, so that they can be distinguished. Then, the CPU 21 controls the display 25 based on the above information. The CPU 21 may display the character string 204b for the 11th to 13th characters in a different character color than that of the character string 204a for the 1st to 10th characters. Alternatively, the CPU 21 may display the character string 204b for the 11th to 13th characters with an underline. The CPU 21 displays the character count sign 206 in a state in which the character count of the characters input by the user is less than or equal to the target character count in a different manner from a state in which the character count of the characters input by the user exceeds the target character count. For example, the CPU 21 displays the character count sign 206 in blue in a state in which the character count of the characters input by the user is less than or equal to the target character count. The CPU 21 also displays the character count sign 206 in red in a state in which the character count of the characters input by the user exceeds the target character count. In other words, the CPU 21 generates information to make the character that exceeds the target character count counted from the beginning of the character string or a background color of the character that exceeds the target character count of the character string displayed on the electronic sticky note to be displayed in the same color as the character count sign 206. Then, the CPU 21 controls the display 25 based on the above information. In a case in which a predetermined target character count is set for the character string displayed on the electronic sticky note, the conventional invention has a problem in that it is impossible to know whether the character count of the character string displayed on the electronic sticky note exceeds the target character count. However, according to the present disclosure, it is possible to know whether the character count of the character string displayed on the electronic sticky note exceeds the target character count.

Next, the CPU 21 determines whether the instruction operation by the user to terminate the editing of the information displayed on the sticky note 101 is accepted via the controller 24 (step S11). In a case in which the instruction operation to terminate the editing of the information displayed on the sticky note 101 is not accepted (step S11; NO), the CPU 21 moves the display control processing to step S11. On the other hand, in a case in which the instruction operation to terminate editing of the information to be displayed on the sticky note 101 is accepted (step S11; YES), the CPU 21 closes the edit screen 200, displays the edited sticky note 101 on the notebook screen 100 (step S12), and ends the display control process. In a case in which the character string displayed on the sticky note 101 exceeds the target character count, in step S12, the CPU 21 may display the portion of the sticky note 101 displayed on the notebook screen 100 that is within the target character count and the portion exceeding the target character count in a different manner, as in step S10. In the sticky note 101 displayed on the notebook screen 100, the CPU 21 may display the portion that is within the target character count and the portion that exceeds the target character count in the same manner. In step S12, the CPU 21 may display a sticky note 101 displayed on the notebook screen 100 with a character count sign 206.

In the edit screen 200, after the target character count has been set by the user and the character string input by the user is displayed in the input region 204, the CPU 21 may accept the click operation of icons other than the character input icon 201, such as the stamp input icon 202, handwritten input icon 203, etc. In the example shown in FIG. 10, the character string input by the user is “ABCDEFGHIJ” and the character count of the characters input by the user is “10”. The example shown in FIG. 10 shows a state in which the stamp input icon 202 is selected by the user. In this case, the CPU 21 displays the character count of the characters input by the user in the character count sign 206, as shown in FIG. 10. In addition, the CPU 21 displays the character count sign 206 in a state in which the character input icon 201 is selected by the user in a different manner from a state in which an icon other than the character input icon 201 is selected by the user. For example, the CPU 21 displays the character count sign 206 in blue or red in a state in which the character input icon 201 is selected by the user. The CPU 21 displays the character count sign 206 in gray in a state in which the icon other than the character input icon 201 is selected by the user. In addition, the CPU 21 may accept the click operation of the icon other than the character input icon 201, such as the stamp input icon 202, the handwriting input icon 203, etc., on the edit screen 200 after the target character count has been set by the user and when no characters have been input by the user. In this case, the CPU 21 does not display the character count sign 206 on the edit screen 200. In a state in which the icon other than the character input icon 201 is selected by the user, when the CPU 21 accepts a hover operation or the click operation on the character count sign 206 by the user via the controller 24, as shown in FIG. 10, the CPU 21 displays a tool tip 207 near the character count sign 206. The tool tip 207 displays the predetermined character string “text character count”, for example.

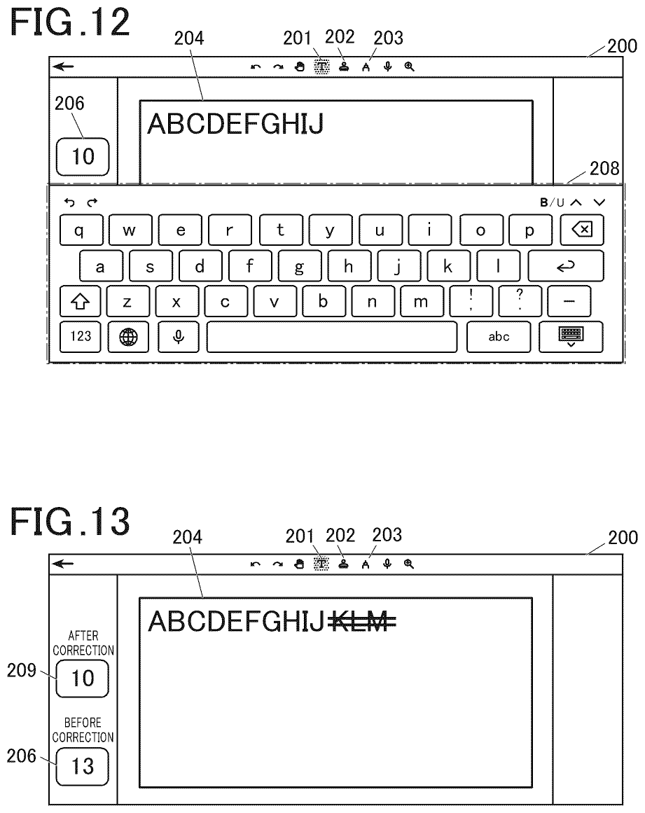

The CPU 21 may also accept the selection operation by the user via the controller 24 in the character string input by the user and displayed in the input region 204 on the edit screen 200. In the example shown in FIG. 11, the character string input by the user is “ABCDEFGHIJ” and the character count of the characters input by the user is “10”. A selected character, which is the character selected by the user, is “FG”, and the character count of the selected character is “2”. In this case, and in a case in which the target character count has been set, the CPU 21 displays a fractional character count in the character count sign 206, as shown in FIG. 11, with a display 206a indicating the number of selected characters selected by the user and a display 206b indicating the character count of the characters input by the user. The CPU 21 may also display a software keyboard 208 as the controller 24 on the edit screen 200, as shown in FIG. 12. In this case, and in a case in which the target character count has been set, the CPU 21 displays the character count sign 206 above the software keyboard 208 on the edit screen 200.

The target character count in the sticky note may be set by a second user (e.g., teacher) different from a first user (e.g., student). In this case, the second user sets the target character count in the target character count input field 205a on the edit screen 200. The second user then drags the sticky note in which the target character count is set onto the send/receive icon 104 on the notebook screen 100 to send the sticky note with the target character count to one or more first user accounts. Next, the first user receives the sticky notes sent from the second user's account by a clicking input operation on the send/receive icon 104 provided on the notebook screen 100. At this time, the CPU 21 of the terminal apparatus 20 used by the first user displays on the notebook screen 100 the sticky note in which the target character count is set and which is sent from the second user's account. In this case, the CPU 21 of the terminal apparatus 20 used by the first user obtains the target character count via the communicator 26 as the predetermined communicator (obtainer). The CPU 21 of the terminal apparatus 20 used by the first user displays the target character count set by the second user in the target character count input field 205a on the edit screen 200 of the sticky note. Here, the target character count input field 205a, in which the target character count is displayed, functions as a target character count sign. When the CPU 21 of the terminal apparatus 20 used by the first user accepts the input of the character by the first user on the edit screen 200 of the sticky note, the CPU 21 displays on the edit screen 200 the character count sign 206 indicating the character count of the characters input by the first user, as in FIG. 8. As in FIG. 9, the CPU 21 of the terminal apparatus 20 used by the first user displays in a different manner the portion of the character string input by the first user and displayed in the input region 204 that is within the target character count counted from the beginning of the character string and the portion exceeding the target character count counted from the beginning of the character string. In other words, the CPU 21 of the terminal apparatus 20 used by the first user generates the information for displaying on the display 25 the electronic sticky note on which the character string for which input is accepted via the controller 24 is displayed, the character count sign 206 indicating the character count of the character string, and the target character count sign indicating the target character count for the character string obtained from another device (terminal apparatus 20 used by the second user) via the communicator 26. The CPU 21 controls the display 25 based on the above information. When the first user has completed inputting the character and other information on the sticky note, the first user drags the sticky note onto the send/receive icon 104 on the notebook screen 100 to send the sticky note to the second user's account. Next, the second user receives the sticky note sent from the first user's account by the clicking input operation on the send/receive icon 104 provided on the notebook screen 100. The second user corrects the information input by the first user on the sticky note and sends the corrected sticky note to the first user's account. The first user then receives the corrected sticky note sent from the second user's account. As shown in FIG. 13, the CPU 21 of the terminal apparatus 20 used by the first user displays in the edit screen 200 of the corrected sticky note the character count sign 206 indicating the character count displayed in the input region 204 before correction and the character count sign 209 indicating the character count displayed in the input region 204 after correction.

As described above, the information processing apparatus (terminal apparatus 20) according to the present embodiment includes the processor (CPU 21) to generate the information for displaying on the display 25 the electronic sticky note on which the character string for which the input is accepted via the predetermined controller 24 is displayed, the character count sign 206 indicating the character count of the character string, and the target character count sign (target character count input field 205a) showing the target character count for the character string obtained via the predetermined controller or the predetermined communicator and to control the display 25 based on the above information. The processor determines whether the character count of the character string displayed on the electronic sticky note is less than or equal to the target character count. The processor generates the information for displaying the character count sign 206 on the display 25 in a different manner in a case in which the character count of the character string displayed on the electronic sticky note is less than or equal to the target character count and in a case in which the character count of the character string exceeds the target character count, and controls the display 25 based on the information. Thus, the user can easily know whether the character count of the character string displayed on the electronic sticky note exceeds the target character count set by the user from the different display modes of the character count sign 206.

In this information processing apparatus (terminal apparatus 20) of the present apparatus, the processor (CPU 21) generates the information for further displaying the target character count input field 205a on the display 25, which accepts the input of the target character count for the character string displayed on the electronic sticky note, and controls the display 25 based on the above information. The processor accepts the input of the target character count in the target character count input field 205a via the controller 24. The processor determines whether the character count of the character string is less than or equal to the target character count accepted via the controller. Therefore, the user can easily know whether the character count of the character string displayed on the electronic sticky note exceeds the target character count set in the target character count input field 205a via the controller by the different display modes of the character count sign 206.

In the information processing apparatus (terminal apparatus 20) of the present embodiment, the processor (CPU 21) accepts the instruction to select at least one character as the selected character in the character string displayed on the electronic sticky note and generates information for displaying on the display 25 the character count of the selected character with the character count of the character string displayed on the electronic sticky note in the character count sign 206, and controls the display 25 based on the above information. Thus, the user can easily ascertain the character count of the selected character.

In the information processing apparatus (terminal apparatus 20) of this embodiment, the processor (CPU 21) generates information for displaying character strings on the electronic sticky note on the display 25 in such a way that the display manner is partially different in a case in which the character count of the character string displayed on the electronic sticky note is less than or equal to the target character count and in a case in which the character count of the character string exceeds the target character count, and controls the display 25 based on the above information. Therefore, the user can easily understand whether the character count of the character string displayed on the electronic sticky note exceeds the target character count or not by the different display modes of the character string.

In the information processing apparatus (terminal apparatus 20) of the present embodiment, in a case in which the character count of the character string displayed on the electronic sticky note exceeds the target character count, the processor (CPU 21) generates the information for displaying on the display 25 in a distinguishable manner, the characters of the character string displayed on the electronic sticky note that are within or equal to the target character count counted from the beginning of the character string and the characters that exceed the target character count counted from the beginning of the character string, and controls the display 25 based on the above information. Thus, the user can easily identify the portion of the character string displayed on the electronic sticky note that exceeds the target character count.

In the information processing apparatus (terminal apparatus 20) of the present embodiment, the processor (CPU 21) generates the information for displaying on the display 25 the characters of the character string displayed on the electronic sticky note that exceed the target character count counted from the beginning of the character string or the background color of the characters that exceed the target character count in the same color as the character count sign 206 and controls the display 25 based on the above information. Thus, the user can easily know that the character count of the character string displayed on the electronic sticky note exceeds the target character count. In addition, the user can easily identify the portion of the character string displayed on the electronic sticky note that exceeds the target character count.

In the information processing apparatus (terminal apparatus 20) of the present embodiment, the processor (CPU 21) generates the information for further displaying on the display 25 a plurality of icons including the character input icon 201 for instructing execution of the character input mode that enables character input to the electronic sticky note, and controls the display 25 based on the above information. The processor generates the information for displaying the character count sign 206 on the display 25 in a different manner when the character input icon 201 is selected and when the character input icon 201 is not selected, and controls the display 25 based on the above information. Thus, the different display modes of the character count sign 206 make it easy for the user to know whether or not the character input mode is being executed.

Although the present disclosure has been specifically described based on the above embodiments, the present disclosure is not limited to the above embodiments and can be modified to the extent that it does not depart from the scope described above. For example, instead of the CPU 21 of the terminal apparatus 20, the CPU 11 of the server 10 may execute the above display control process. In this case, the CPU 21 of the terminal apparatus 20 as the second information processing apparatus accepts the input of the character string via the predetermined controller 24 and causes the character string to be transmitted to the first information processing apparatus (server 10) via the second communicator (communicator 26). The CPU 21 functions as the second processor. The CPU 11 of the server 10 transmits via the first communicator the display information for displaying the electronic sticky note on which the character string obtained from the second information processing apparatus via the first communicator (communicator 14) is displayed, the character count sign 206 indicating the character count of the character string, and the target character count sign (target character count input field 205a) showing the target character count for the character string obtained via the first communicator. In this case, the CPU 11 functions as the first processor and the server 10 functions as the first information processing apparatus. Next, the CPU 21 of the terminal apparatus 20 displays on the display 25 the electronic sticky note, the character count sign 206 and the target character count sign based on the display information obtained from the first information processing apparatus via the second communicator. Next, the CPU 11 of the server 10 determines whether the character count of the character string displayed on the electronic sticky note is less than or equal to the target character count. Next, the CPU 11 sends the display information to the second information processing apparatus to display the character count sign 206 in a different display manner in a case in which the character count of the character string displayed on the electronic sticky note is less than or equal to the target character count and in a case in which the character count of the character string exceeds the target character count.

Although the above embodiment discloses an example of using the non-transitory recording medium of the storage 13 as a computer-readable medium for the program of the present disclosure, it is not limited to this example. Other computer-readable media such as flash memory and portable recording media such as CD-ROMs can be applied. A carrier wave is also applicable to the present disclosure as a medium for providing data for the programs in the present disclosure via communication lines.

What is claimed is:

1. An information processing apparatus comprising:
a processor, wherein the processor is configured to,
generate data for displaying on a display an electronic sticky note on which a character string that is accepted by input through a controller is displayed, a character count sign indicating a character count of the character string, and a target character count sign indicating a target character count for the character string obtained through the predetermined controller or a predetermined communicator,
determine whether the character count of the character string is less than or equal to the target character count, and
generate the data to display the character count sign in a different display manner on the display in a case in which the character count of the character string is less than or equal to the target character count and in a case in which the character count of the character string exceeds the target character count.

2. The information processing apparatus according to claim 1, wherein the processor is configured to,
generate the data to further display on the display a target character count input field in which an input of the target character count for the character string is accepted,
accept input of the target character count in the target character count input field through the controller, and
determine whether the character count of the character string is less than or equal to the target character count accepted through the controller.

3. The information processing apparatus according to claim 1, wherein the processor is configured to,
accept an instruction to select at least one character from the character string displayed on the electronic sticky note as a selected character, and
generate the data to display on the display the character count of the selected character together with the character count of the character string in the character count sign.

4. The information processing apparatus according to claim 1, wherein the processor is configured to generate the data to display on the display the character string on the electronic sticky note in the display manner that is partially different in a case in which the character count of the character string is less than or equal to the target character count, and in a case in which the character count of the character string exceeds the target character count.

5. The information processing apparatus according to claim 1, wherein, in a case in which the character count of the character string exceeds the target character count, the processor is configured to generate the data to display on the display in a distinguishable manner the character that is in the character string displayed in the electronic sticky note and that is within the target character count counted from a beginning of the character string and the character that is in the character string displayed in the electronic sticky note and that exceeds the target character count counted from the beginning of the character string.

6. The information processing apparatus according to claim 5, wherein the processor is configured to generate the data to display on the display the character that exceeds the target character count or a background color of the character that exceeds the target character count in a same color as the character count sign.

7. The information processing apparatus according to claim 1, wherein the processor is configured to,
further display on the display a plurality of icons, the plurality of icons including a character input icon that is used to instruct executing of a character input mode that enables input of a character to the electronic sticky note, and
generate the data to display the character count sign on the display in the different display manner when the character input icon is selected and when the character input icon is not selected.

8. An information processing system comprising:
a first information processing apparatus provided with a first communicator and a first processor; and
a second information processing apparatus provided with a controller, a display, a second communicator, and a second processor,
wherein,
the second processor is configured to accept an input of a character string through the controller and to transmit the character string to the first information processing apparatus through the second communicator,
the first processor is configured to transmit to the second information processing apparatus through the first communicator display information to display an electronic sticky note on which the character string obtained from the second information processing apparatus through the first communicator is displayed, a character count sign indicating a character count of the character string, and a target character count sign indicating the target character count for the character string obtained through the first communicator,
the second processor is configured to display on the display the electronic sticky note, the character count sign, and the target character count sign based on the display information obtained from the first information processing apparatus through the second communicator, and
the first processor is further configured to,
determine whether the character count of the character string is less than or equal to the target character count, and
transmit to the second information processing apparatus display information to display the character count sign in a different display manner in a case in which the character count of the character string is less than or equal to the target character count and in a case in which the character count of the character string exceeds the target character count.

9. An information processing method executed by an information processing apparatus, the method comprising:
generating data for displaying on a display an electronic sticky note on which a character string that is accepted by input through a controller is displayed, a character count sign indicating a character count of the character string, and a target character count sign indicating a target character count for the character string obtained through the predetermined controller or a predetermined communicator,
determining whether the character count of the character string is less than or equal to the target character count, and
generating the data to display the character count sign in a different display manner on the display in a case in which the character count of the character string is less than or equal to the target character count and in a case in which the character count of the character string exceeds the target character count.
